(19) United States
(12) Patent Application Publication
(10) Pub. No.: US 2007/0164552 A1
(43) Pub. Date: Jul. 19, 2007

(54) Fluid containment system

(75) Inventors: Karl J. Bauer, Garner, IA (US); Michael A. Brainard, Manson, IA (US); William J. Bunkofske, Garner, IA (US); Steve C. Fairbanks, Cedar Falls, IA (US)

Correspondence Address: FOLEY & LARDNER LLP, 777 EAST WISCONSIN AVENUE, MILWAUKEE, WI, 53202-5306, US

(73) Assignee: Oshkosh Truck Corporation

(21) Appl. No.: 11/604,657

(22) Filed: Nov. 27, 2006

Related U.S. Application Data
(60) Provisional application No. 60/740,107, filed on Nov. 28, 2005.

(51) Int. Cl. B60P 3/22

(52) U.S. Cl. 280/838

(57) ABSTRACT

A fluid reservoir constructed of a translucent, ultraviolet light stable, and impact resistant polyethylene material. The reservoir includes integrated stiffening ribs, molded into the side walls of the reservoir, and a mounting surface suitably configured for receiving reservoir accessories. The reservoir accessories include a fluid transfer pump and a breather filter.

### CROSS-REFERENCE TO RELATED PATENT APPLICATIONS

This application claims priority from Provisional Application U.S. application Ser. No. 60/740,107, filed Nov. 28, 2005, incorporated herein by reference in its entirety.

### BACKGROUND OF THE INVENTION

This invention is directed to a fluid containment system. More particularly, this invention is directed to a fluid reservoir for the transportation of fluids, such as oils, water, engine antifreeze, and the like, as well as used fluids of the same types.

Typical fluid reservoirs, or tanks, are made of steel sheets, welded together to form the tank. However, the use of steel usually leads to rust and water contamination of the fluid being stored inside the tank. Furthermore, weld points form stress points, which lead to leaks and loss of fluids. In addition, the common storage tanks do not adequately prevent loss of fluid due to condensation within the tank. The most common steel tanks incur another problem inherent in their basic design, which is the heavy weight of steel, resulting in serious weight constraints for a given gross vehicle weight.

Thus, there is a need for a fluid reservoir capable of alleviating the aforementioned problems. There is also a need for a fluid tank design that overcomes above limitations by eliminating stress points, which may produce fluid leaks. there is also a need for a fluid reservoir design that eliminates condensation inside the tank, as well as reduces contamination of the fluids due to rust and water. In addition, there is a need for a fluid reservoir system design that meets weight constraints when intended to be mounted on service utility vehicles.

### SUMMARY OF THE INVENTION

There is provided a vehicle comprised of non-metallic material that is capable of receiving a variety of service fluids, including, without limitation, oil, used oil, antifreeze, used antifreeze, hydraulic fluid, used hydraulic fluid, water, waste water, and the like.

Further, there is provided a fluid reservoir design that eliminates stress points, such as weld joints that may produce fluid leaks.

Still further, there is provided a fluid reservoir design that reduces or substantially eliminates contamination of the fluids inside the fluid reservoir due to rust and water.

Still further, there is provided a fluid reservoir having integrated stiffening ribs.

Further, there is provided a fluid reservoir comprising a reservoir body that includes side walls, a bottom component, a top component, and at least one stiffening rib. The bottom component and the top component are suitably engaged with the side walls to form the reservoir body. The reservoir body is suitably comprised of non-metallic material. The fluid reservoir also includes a mounting surface fixedly attached to the reservoir body and configured for receiving reservoir accessories. The at least one stiffening rib is, preferably, integrated into at least one side wall of the reservoir body, for example molded into it. The non-metallic material is suitably a translucent, ultraviolet stable and impact resistant material. The non-metallic material is, preferably, polyethylene plastics. In a preferred embodiment, the mounting surface is coupled to the top component of the reservoir body.

Still further, the vehicle may be provided with a suction line port, which is engaged with the reservoir body and configured to receive a suction line from a remote fluid transfer pump. The suction line port is, preferably, located in a bottom portion of a side wall. The top component of the reservoir body further comprises a filler opening configured to receive a lockable fill cap. In another embodiment, a fluid transfer pump is included in the reservoir accessories to be mounted to the top component of the reservoir body. Thus, in this embodiment, the mounting surface further includes a pump mount configured to receive a fluid transfer pump. In another embodiment, the reservoir accessories, preferably, also include a breather filter. Hence, in this embodiment, the mounting surface further includes a breather filter port adapted to receive a breather filter.

The vehicle is capable of production in variable capacities. In a preferred embodiment, the fluid reservoir is suitably mounted within a mobile truck body.

Still other aspects will become readily apparent to those skilled in this art from the following description wherein there is shown and described a preferred exemplary embodiment of a vehicle, simply by way of illustration of one of the best modes suited for to carry out the invention. As it will be realized by those skilled in the art, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, and together with the description serve to explain the principles of a vehicle. In the drawings:

FIG. 1 is a schematic drawing illustrating an exemplary embodiment of a fluid reservoir;

FIG. 2 is a schematic drawing illustrating a mounting surface of the reservoir illustrated in FIG. 1;

FIG. 3 is a schematic illustration of a truck type vehicle including a vehicle.

### DETAILED DESCRIPTION OF THE PREFERRED EMBODIMENTS

This invention is directed to a fluid containment system. In particular, this invention is directed to a fluid reservoir comprised of a non-metallic material. More particularly, this invention is directed to a fluid reservoir constructed of a translucent, ultraviolet stable, impact resistant plastic material. In accordance with the preferred embodiment of the present invention, the fluid reservoir is advantageously implemented as being mounted to a mobile truck body and capable of receiving a variety of service fluids, including, without limitation, oil, used oil, antifreeze, used antifreeze, hydraulic fluid, used hydraulic fluid, water, waste water, and the like.

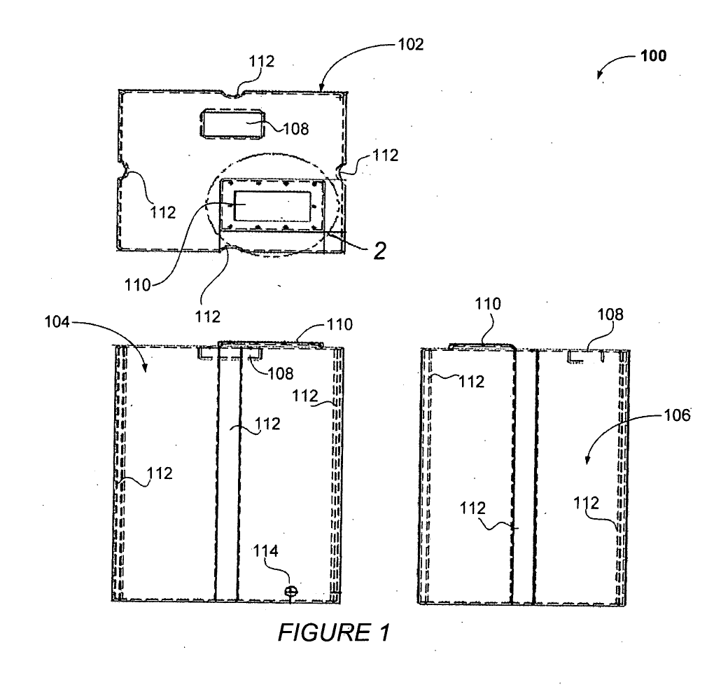

Turning now to FIG. 1, there is shown a schematic drawing of a top view 102, a side view 104 and a front view 106 of a fluid reservoir 100 in accordance with the present invention. The fluid reservoir 100 includes a reservoir body including side walls 103, a bottom component 105, a top component 107. The bottom component 105 and the top component 107 are engaged with the side walls 103 to form the reservoir body. The top component 105 includes a filler opening 108, a mounting surface 110. The side walls 103 include stiffening ribs 112 that are suitably integrated into the side walls 103. In a preferred embodiment, the stiffening ribs 112 are molded into the side walls 103. In another preferred embodiment, the fluid reservoir 100 is constructed using polyethylene plastics, having translucent, ultraviolet stable, and impact resistant properties. For example and without limitation, suitable polyethylene plastics used in accordance with the present invention vary in thickness from ⅜ to ½ of an inch. The skilled artisan will appreciate that the use of polyethylene as the material from which the fluid reservoir 100 is constructed results in an average weight savings of 82.5% over comparable steel reservoirs. Thus, the skilled artisan will further appreciate that such a weight savings enables the instant fluid reservoir to carry up to 29% more than the steel counterpart.

As it will be appreciated by a skilled artisan, the fluid reservoir 100 is capable of production in a variety of capacities, ranging, for example and without limitation, from 70 U.S. gallons to 350 U.S. gallons of fluid. It will be appreciated by those skilled in the art that the reservoir 100, as shown in FIG. 1, includes four (4) stiffening ribs 112, however larger reservoirs 100 suitably include additional stiffening ribs 112, so as to maintain the structural integrity of the reservoir 100 in response to the greater amount of fluid contained therein. The filler opening 108 is suitably configured so as to receive a lockable fill cap, for example a 2-inch fill cap, so as to prevent unwanted contamination of the fluid contained within the reservoir 100. In addition, the mounting surface 100 is suitably adapted to receive a pump mount (not shown) on which a suitable fluid transfer pump is affixed. The fluid transfer pump is, for example and without limitation, a pneumatic pump. Preferably, the mounting surface 110 is suitably adapted to receive, in addition to or in replacement of the pump, a breather filter, so as to prevent unwanted fumes from escaping from the reservoir 100 as fluid is introduced thereinto. In one particular embodiment, the fluid reservoir 100 further includes a fitting 114 suitably adapted to receive a suction line from a remote hydraulic or pneumatic pump (not shown).

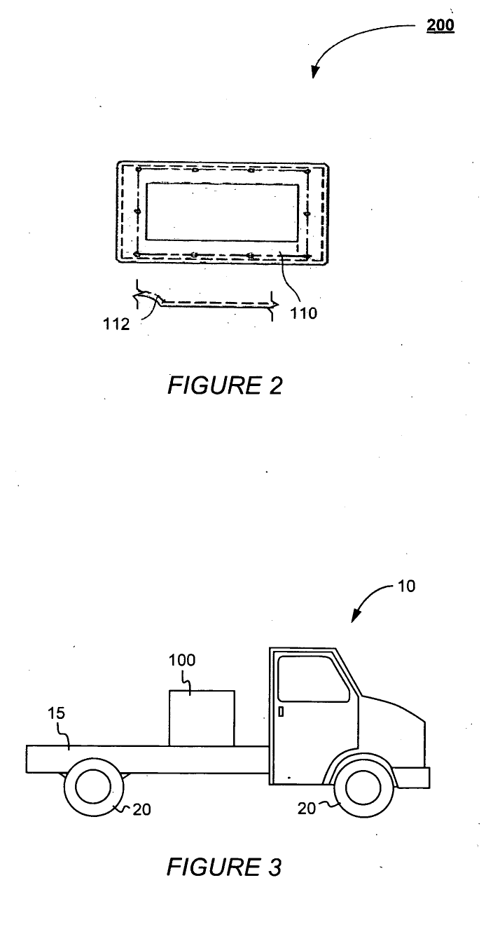

FIG. 2 illustrates a mounting surface 200 for a mounting plate in accordance with the present invention. It will be understood by those skilled in the art that the mounting surface 200 is suitably adapted in shape and size, so as to allow for the mounting of various pumps, filters and the like.

Referring to FIG. 3, a vehicle 10 is shown according to an exemplary embodiment. Vehicle 10 (shown as a flat-bed truck) includes a support structure 15 (e.g., frame, bed, platform, etc.) and one or more support members 20. According to various exemplary embodiments, support members 20 may be wheels, tracks, or any other members that are in communication with both the ground and the support structure 15. A fluid reservoir 100 is coupled to the support structure 15 and is configured to contain a liquid to be transported by the vehicle 10.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A vehicle comprising:
a reservoir body including side walls, a bottom component, a top component, and at least one stiffening rib, the bottom component and the top component being engaged with the side walls to form the reservoir body; and
a mounting surface fixedly attached to the reservoir body and configured for receiving reservoir accessories;
wherein the reservoir body is comprised of non-metallic material.

2. The vehicle of claim 1 wherein the at least one stiffening rib is integrated into at least one side wall of the reservoir body.

3. The vehicle of claim 2 wherein the at least one stiffening rib is molded into the at least one side wall of the reservoir body.

4. The vehicle of claim 1 wherein the non-metallic material is translucent.

5. The vehicle of claim 1 wherein the non-metallic material is ultraviolet light stable.

6. The vehicle of claim 1 wherein the non-metallic material is impact resistant.

7. The vehicle of claim 1 wherein the non-metallic material is polyethylene plastics.

8. The vehicle of claim 1 wherein the mounting surface is coupled to the top component of the reservoir body.

9. The vehicle of claim 1 further comprising a suction line port engaged with and in fluid communication with the reservoir body and configured to receive a suction line from a remote fluid transfer pump.

10. The vehicle of claim 9 wherein the suction line port is located in a bottom portion of a side wall of the vehicle.

11. The vehicle of claim 1 wherein the top component of the reservoir body further comprises a filler opening configured to receive a lockable fill cap.

12. The vehicle of claim 1 wherein the mounting surface further includes a pump mount configured to receive a fluid transfer pump.

13. The vehicle of claim 1 wherein the mounting surface further includes a breather filter port configured to receive a breather filter.

14. The vehicle of claim 1 wherein the fluid reservoir is mounted within a mobile truck body.

15. A vehicle comprising:
a support structure;
a plurality of support members coupled to the support structure; and
a vehicle coupled to the support structure, the vehicle comprising:
a reservoir body including side walls, a bottom component, a top component, and at least one stiffening rib, the bottom component and the top component being engaged with the side walls to form the reservoir body; and
a mounting surface fixedly attached to the reservoir body and configured for receiving reservoir accessories;
wherein the reservoir body is comprised of non-metallic material.

16. The vehicle of claim 15 wherein the at least one stiffening rib is integrated into at least one side wall of the reservoir body.

17. The vehicle of claim 16 wherein the at least one stiffening rib is molded into the at least one side wall of the reservoir body.

18. The vehicle of claim 15 wherein the non-metallic material is translucent.

19. The vehicle of claim 15 wherein the non-metallic material is ultraviolet light stable.

20. The vehicle of claim 15 wherein the non-metallic material is impact resistant.

21. The vehicle of claim 15 wherein the non-metallic material is polyethylene plastics.

22. The vehicle of claim 15 wherein the mounting surface is coupled to the top component of the reservoir body.

23. The vehicle of claim 15 further comprising a suction line port engaged with and in fluid communication with the reservoir body and configured to receive a suction line from a remote fluid transfer pump.

24. The vehicle of claim 23 wherein the suction line port is located in a bottom portion of a side wall of the vehicle.

25. The vehicle of claim 15 wherein the top component of the reservoir body further comprises a filler opening configured to receive a lockable fill cap.

26. The vehicle of claim 15 wherein the mounting surface further includes a pump mount configured to receive a fluid transfer pump.

27. The vehicle of claim 15 wherein the mounting surface further includes a breather filter port configured to receive a breather filter.

28. The vehicle of claim 15 wherein the fluid reservoir is mounted within a mobile truck body of the vehicle.
